(19) United States
(12) Patent Application Publication
(10) Pub. No.: US 2001/0033657 A1
(43) Pub. Date: Oct. 25, 2001

(54) Method and systems for identifying the existence of one or more unknown programs in a system

(76) Inventors: Richard J. Lipton, Atlanta, GA (US); Dimitrios Serpanos, Patras (GR)

Correspondence Address: Joseph Giordano, Esq., Telcordia Technologies, Inc., 445 South Street, Room 1G-112R, Morristown, NJ, 07960, US

(21) Appl. No.: 09/765,269

(22) Filed: Jan. 18, 2001

Related U.S. Application Data
(60) Provisional application No. 60/176,696, filed on Jan. 18, 2000.

(51) Int. Cl. H04N 7/167; H04L 9/32

(52) U.S. Cl. 380/201; 713/188

(57) ABSTRACT

Disclosed are methods and systems for improving data security in a computer system. In particular, disclosed are methods and systems for writing a sequence of pseudorandom bits to a computer system's memory, where the number of bits written is equal to the expected size of the computer system's free memory. As such, if one or more unknown programs are resident in the computer system's memory, the methods and systems will be unable to write bits to the memory in which the unknown programs reside. Then, these methods and systems attempt to read these bits from the computer system's memory. Thus, if an unknown program is resident in the computer system's memory, the unknown program will have to correctly guess the bits that were attempted to be written in the memory in which the unknown program resides. Thus, if the read bits do not match the written bits, the existence of an unknown program may be determined. Further disclosed are methods and systems for determining if any bits are improperly transmitted to an unauthorized location. For example, in certain systems it is desirable to maintain data security and to ensure that secure bits are not improperly transmitted to someplace other than for use by an application program. Such methods and systems check for any such unauthorized input/output activity.

### CROSS-REFERENCE TO RELATED APPLICATIONS

This application claims the benefit of U.S. Provisional Application No. 60/176,696, filed Jan. 18, 2000, the contents of which are hereby incorporated by reference. Additionally, the application of Richard Lipton and Dimitrios Serpanos, entitled “Method and Systems for Data Security,” Attorney Docket No. APP-1360 US, contains subject matter related to the present application, and is assigned to the assignee hereof and has been filed on the same date as the present application.

### BACKGROUND OF THE INVENTION

The present invention relates to security in communications systems, and more particularly, to methods and systems for ensuring secure communications using a “spy”.

One of the main concerns of many service providers is the security of client systems. When a client receives a service, the user may obtain access to proprietary data that the user is supposed to use only once and/or not distribute to other clients. Typical examples of such services include video-on-demand services (where a client should view the video data only once and not transmit the data to other users) and electronic books (where the user should be able to read an electronic book only on a provided device and not distribute contents of the book to others). From the point of view of the service provider, the client system should be secure enough to use the sensitive data securely. Secure use in this environment means that the clients' system should not be able to use the data more than once (e.g., in the video-on-demand service) or distribute it to other users (i.e., copy it and/or transmit it to a remote system).

As an example, for video-on-demand service, a server delivers a video stream to a client that displays the video stream in real-time. Various threats exist against such a service with conventional technology even if the data is encrypted. An example of such a threat is a “screen-scrapper” program, which copies the information displayed on the screen (after it has been decrypted) and then writes the information to a file or transmits it over the network to unauthorized (illegal) users. Many applications and systems, such as electronic books for exclusive use, software updating, etc. are vulnerable to the “screen-scrapper” type of attack. A client system may also misuse data by running a “stealing program.”

Such programs can be run either on purpose by the client, or by an illegal intruder such as a virus affecting the client system without knowledge of the client system. Viruses typically have two main goals: The first is to hide (in order to survive and replicate inconspicuously), and the second is to perform some action (undesired, most probably by the system's legitimate users). As a result, the development of viruses has triggered the development of anti-virus technology.

Conceptually, viruses includes a hiding code, replicating code, and an action code. The hiding code is responsible for entering a target system inconspicuously, and hiding the virus so that it remains undetected. The replicating code is responsible for virus replication and migration to other systems. Finally, the action code is responsible for performing some action on the local system.

Since viruses need to be executed to perform their goal, they typically hide in code segments of other programs or files. There are three main classifications for viruses, each of which is based on the placement of the viruses code (i.e., on the function of their hiding code, which places the virus code in difficult to identify areas): boot sector viruses, file appending viruses, and macro viruses. Boot sector viruses hide in system code, and may hide either in the boot sector of hard disks or diskettes. File appending viruses hide in executables, and macro viruses hide in macros in a data file.

Anti-virus protection is normally achieved through execution of programs that detect the presence of a virus, identify and destroy the virus and reverse (if possible) the damage caused by the virus. Typically, detection and identification of a virus is based either on behavior and/or structure of the virus. Behavior-based anti-virus programs detect viruses through their activity, while structure-based ones detect them through identification of their code. Both methods require non-trivial functionality in order to avoid false identification of legitimate programs as viruses. Furthermore, anti-virus programs need to be able to identify old as well as newly developed viruses.

The paradigm used by the computer community, in regard to viruses, is simple: virus programs are the criminals, who follow the “hide- and- hit” approach, while anti-virus programs are the police who are chasing the criminals, trying to identify them, destroy them and repair the damage they have caused up to that point (if possible).

Based on this paradigm, the authors of viruses are focusing on the development of new “hiding” techniques for new viruses as well as creating successful mutations of previously detected and recognized viruses. Authors of anti-virus programs are collecting information on many viruses and improving techniques for identifying viruses, either through their behavior or their structure in data, program files or stand-alone.

There are some assumptions in this paradigm that are presently driving anti-virus technology, such as that for any virus V( ), there can be a program D( ) that detects V( ), and that the anti-virus programs are secure and can perform any activity required for the defense of the computer system.

These assumptions, however, aren't necessarily true. For example, a virus may follow a man-in-the-middle attack and infect the anti-virus programs residing in the system. Analogously to the biological HIV virus, such a computer virus attacks the defense system of the victim. Since the intruder controls the defense mechanisms of the system, the system can become unable to detect and/or react to any undesirable activity.

The following presents an example of how an HIV-type virus, V( ), could attack a system with an anti-virus detector, D( ). First, a virus, V( ), creates a new program, D′( ), with the following two properties: D′( ) looks the same as D( ) to users, and D′( ) does not really detect viruses. Next, the virus, V( ), replaces D( ) with D′( ). This attack results in V( ) becoming completely undetected, since the new program, D′( ), is undetectable from other application programs or the system's human user(s) (since it provides the same interface), and the new program, D′( ), does not detect viruses (at least not V( )).

Although the effectiveness of the virus's attack against D( ) is independent of D( )'s virus detection scheme(s), functionality can be added to D( ) to make this virus attack difficult. For example, D( ), can “hide,” or D( ), can be constructed so that it communicates periodically with a remote server (servers) to verify the integrity of D( ). These counter-measures can be circumvented though by a more sophisticated virus, V( ), as discussed below.

If D( ) “hides,” then it uses some “hiding” technique similar to the one used by typical viruses, and is thus susceptible to detection in the same fashion as viruses. Any detection technique developed for anti-virus technology can be used by V( ) to detect and identify D( ).

If D( ) communicates periodically with a server in order to have the server ensure the integrity of D( ), then V( ) can circumvent this defense by becoming the man-in-the-middle between D( ) and its users (e.g., programs running on remote servers). All requests, whether encrypted or not, directed to D( ) will arrive at D′Q, where D′( ) is considered part of V( ). Then, D′( ) runs D( ) as a subroutine and returns the results exactly as D( ) would return them.

Another example of a security breach is when a virus takes over control of the client, i.e. the virus becomes the man-in-the-middle between the server and the client rather than between the client and an anti-virus program. The virus, since it controls the client, can then run the client as a subroutine and obtain all the information necessary for communication with the servers (and the external world in general). In this scenario the virus can deceive the server and pretend that it is the authorized client that is under its control.

The man-in-the-middle attack, discussed above, can be implemented in various ways in many environments. Presently, the proposed defense methods for addressing this problem focus on the development of protocols that enable secure key exchange or generation for secure communication. Examples include protocols using personalized information (U.S. Pat. No. 5,793,866), certificates (U.S. Pat. No. 5,515,441), or use of one-way hash functions (U.S. Pat. No. 5,450,493). These protocols, however, do not establish the integrity of the communicating parties, such as a client in service environments. Although this approach is reasonable in systems where the clients are considered secure, such as with smart cards (U.S. Pat. Nos. 5,809,140 and 5,448,045), these methods are vulnerable in environments where the clients can be compromised.

Further, many of the present video distribution systems that have been developed are susceptible to the man-in-the-middle attack. For example, the system disclosed in U.S. Pat. No. 5,825,879 displays an encrypted digital video stream and defends against illegal content copying through use of secure memory on a decoding system and through transformation of the digital video stream to analog before display. This method is vulnerable to compromised clients that retransmit the analog video stream. Similar problems exist in proposed systems where clients are allowed to subscribe to packages of services (U.S. Pat. No. 5,671,276), or in systems where clients obtain decryption keys after successful authentication (U.S. Pat. No. 5,046,092).

Another method used for virus detection examines programs stored or in use in a system through fingerprints, etc. (e.g., U.S. Pat. Nos. 5,421,006, 5,440,723, and 5,684,875). Also, U.S. Pat. No. 5,684,875 mentions a method, where a client's protection program may measure the amount of free main memory (RAM) in the system and compare it with nominal values, to identify whether there is a “hidden” program (virus) resident in the main memory. This method may not be successful though, if the size of the virus is such that the difference between the size of free memory and the nominal values is small. Unless the system is very limited, it is extremely difficult to calculate correct nominal values, and it is further extremely difficult to define what the difference between free memory size and nominal values must be to identify the existence of a virus. In addition, the method of U.S. Pat. No. 5,684,875 is susceptible to attacks where the virus can manipulate the value of the variable that measures the free main memory by, for example, incrementing the measurement so that virus hides its size in the increased measurement.

Other approaches in anti-virus technology focus on ensuring the integrity of key system portions, such as a boot sector (U.S. Pat. No. 5,802,277), or ensuring the security and integrity of transactions to a hard disk (U.S. Pat. No. 5,483,649). In another approach, the system is booted safely (securely) from a secure disk partition and the integrity of all system software is verified through secure programs that are guaranteed by their storage in the secure disk partition (U.S. Pat. No. 5,537,540). The approach is also vulnerable though to attacks after the booting of the system, such as, for example, if the system is connected to a network.

The above discussed security problems may occur in a wide range of applications and services ranging from electronic commerce to video distribution and personal services. Accordingly, there is a need for improved methods and systems for ensuring the security of computer systems.

### SUMMARY OF THE INVENTION

Methods and systems consistent with the invention, as embodied and broadly described herein, comprise a method for identifying the existence of one or more unknown programs in a system, including attempting to write a predetermined number of bits to a memory in the system, wherein the predetermined number of bits is based on size of the memory, determining if any of the bits attempted to be written to the memory are transmitted to someplace other than the memory, reading from the memory a number of bits equal to the predetermined number of bits attempted to be written to the memory, determining if the bits read from the memory match the bits attempted to be written to the memory, and determining that no unknown program is resident in the memory if the read bits match the bits attempted to be written and that none of the bits attempted to be written were transmitted to someplace other than the memory.

In another embodiment, such methods and systems comprise a system, including at least one processor, a memory, at least one storage device, and a circuit. The storage device stores a program that the at least one processor executes to perform a method including the steps of attempting to write a predetermined number of bits to the memory, where the predetermined number is based on size of the memory, reading a number of bits from the memory that is equal to the predetermined number of bits attempted to be written to the memory, and determining if the bits read from the memory match the bits attempted to be written to the memory. Further, the circuit determines if any of the bits attempted to be written to the memory were transmitted to someplace other than the memory.

In yet another embodiment, such methods and systems comprise an apparatus for identifying one or more unknown programs in a system, including a storage device storing a program that a processor executes to perform a method comprising the steps of: attempting to write a predetermined number of bits to a memory in the system, reading a number of bits from the memory that is equal to the predetermined number of bits attempted to be written to the memory, and determining if the bits read from the memory match the bits attempted to be written to the memory. Further, such apparatus includes a circuit that determines if any of the bits attempted to be written to the memory are transmitted to someplace other than the memory.

In yet another embodiment, such methods and systems comprise a method, including the steps of: executing an application program at an apparatus that includes at least a processor and a memory, receiving a plurality of bits at the apparatus for use by the application program, determining if at least one of the plurality of received bits is improperly transmitted to someplace other than for use by the application program, and transmitting a message if it is determined that the at least one of the plurality of received bits is improperly transmitted.

In yet another embodiment, such methods and systems comprise an apparatus for operation with a system including a memory that includes a circuit that determines if any of a plurality of bits received by the system are improperly transmitted to someplace other than for use by an application program running in the system and that transmits a message if it is determined that any of the received bits are improperly transmitted.

### BRIEF DESCRIPTION OF THE DRAWINGS

In the Figures:

FIG. 1 illustrates a client-server environment, in accordance with methods and systems consistent with the invention;

FIG. 2 illustrates a block diagram of a client computer that includes a spy, in accordance with methods and systems consistent with the invention;

FIG. 3 illustrates a method for detecting illegal activity during the transmission of secure data to a client, in accordance with methods and systems consistent with the invention;

FIG. 4 illustrates a method for ensuring the safe execution of a non-realtime application in which a client computer is brought to a clean state prior to starting the application, in accordance with methods and systems consistent with the invention;

FIG. 5 illustrates a method for ensuring the safe execution of a realtime application, in accordance with methods and systems consistent with the invention; and

FIG. 6 illustrates a method that may be used for verifying that a client computer is not running any unauthorized programs, in accordance with methods and systems consistent with the invention.

### DETAILED DESCRIPTION

Reference will now be made in detail to the preferred embodiments of the invention, examples of which are illustrated in the accompanying drawings. Wherever possible, the same reference numbers will be used throughout the drawings to refer to the same or like parts.

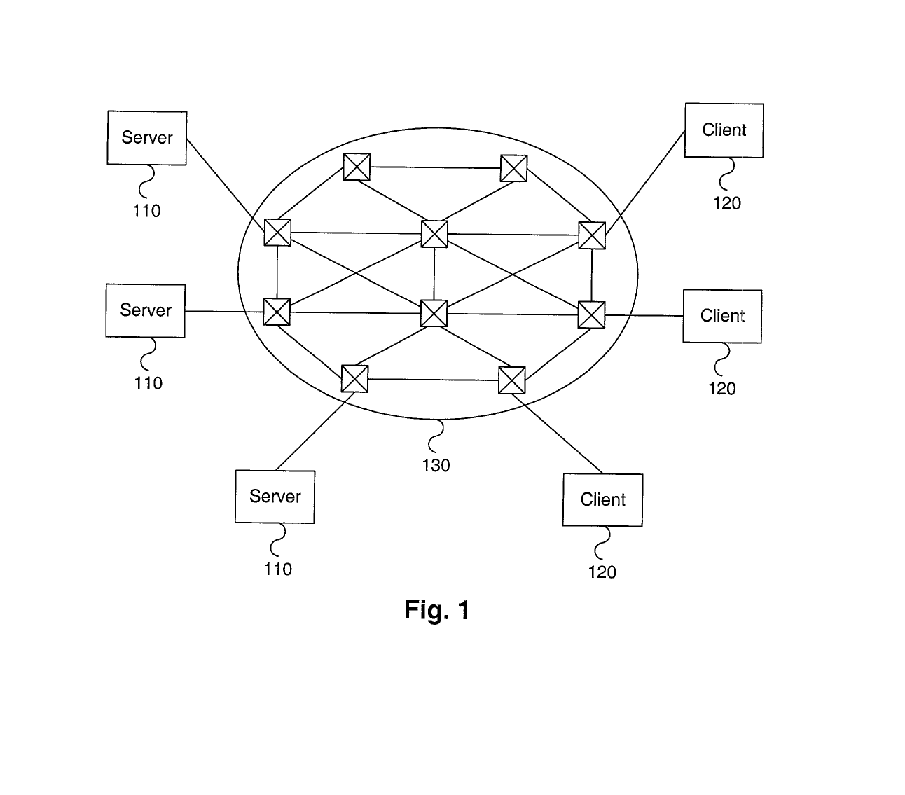

FIG. 1 illustrates a client-server environment, where services are provided by servers 110 to clients 120 over a network 130, such as the Internet, in accordance with methods and systems consistent with the invention. In such a system, a client 120 may request from a server 110 one or more objects for one-time access (in case of real-time applications) or exclusive access (in case of download applications). An object may include, for example, a video stream, electronic book, program, data file, etc., and may be used for real-time or non-real-time applications. In response, the server 110 provides data to the requesting client 120.

In such a system, the servers 110 and the network 130 may be secure, but the clients 120 may be compromised and susceptible to software attacks. Further, client 120 may be attacked by an external enemy with a virus-like attack, or the client 120 itself may be an enemy.

For simplicity, the following description assumes that there is only one server 110 in the system. The results apply to and are easily extended to the case of multiple servers. In an embodiment, a trusted device, called a spy, is attached to the client 120. The client 120 then uses the spy to establish secure communication between the server 110 and the client 120. Further, the spy ensures that the application is executed in a “safe” environment at the client. The spy accomplishes this by verifying that either no offending program (i.e. a virus) resides in the client's memory, or detecting such a program as soon as the program attempts to steal data.

The spy preferably has the following three characteristics, in accordance with an embodiment of the invention: it includes a passive Input/Output (I/O) device that is not placed in a critical path of the client 120; it detects I/O activity, such as disk accesses and network transmissions; and it has some computational power and memory, so that it can perform cryptographic computations (e.g., public-key cryptography, etc.).

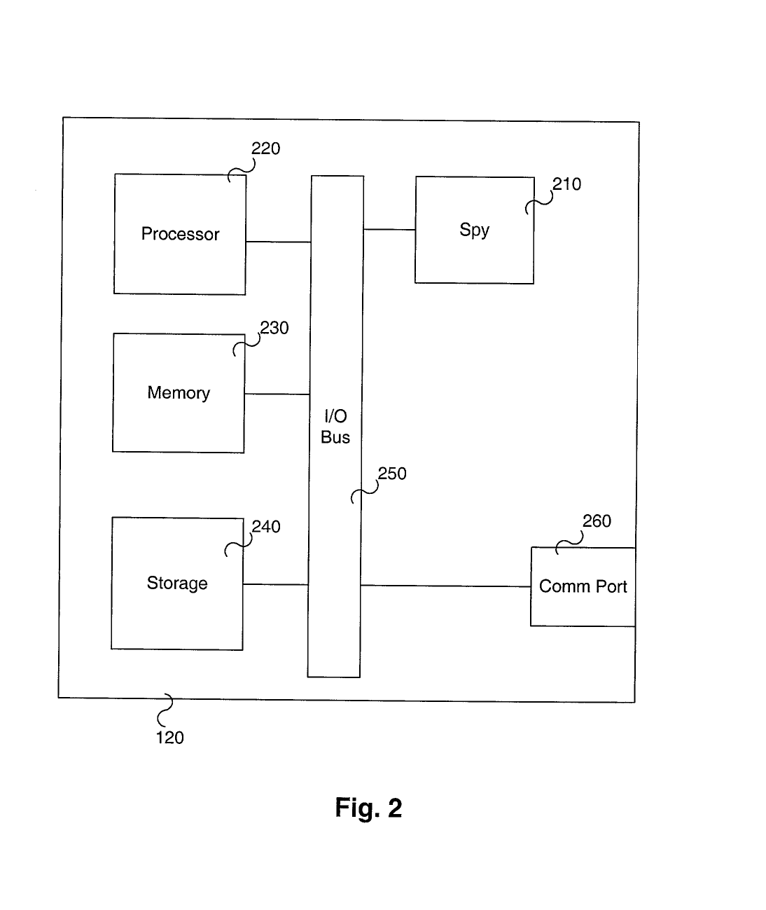

FIG. 2 illustrates a block diagram of a client computer 120 that includes a spy 210, in accordance with methods and systems consistent with the invention. As illustrated, the client computer 120 may include a processor 220, a memory 230, a storage device 240, an I/O bus 250, a communication port 260, and a spy 210. Further, the client computer may include a monitor or may connect to one (not shown). The storage device may include a conventional hard drive. The spy 210 may be included on a simple Personal Computer Memory Card International Association (PCMCIA) type Personal Computer (PC) card, a board, or some other type of module, attached to the client I/O bus 250. The spy 210 may also include an embedded processor (not shown) and some memory (not shown) to perform cryptographic computations. Further, the spy 210 may be implemented as a tamper proof device. Also, the spy 210 may be implemented using smart-card technology. Accordingly, there are numerous technologies that may be used to implement the spy 210, such as, for example, PCMCIA, PCMCIA with tamper proof properties, and smart card technology.

To identify data loss due to disk file accesses or network transmissions, the spy 210 may be attached to the client system so that all the disk and network device transactions are visible to the spy. If a technology is used where a disk or a network device is attached to the client memory bus and not the I/O bus, then the spy 210 needs to be implemented in such a way so that the necessary transactions are visible to it. Accordingly, the spy 210 may be a simple, passive, low-cost device.

Spy-server secure communications may be implemented through authentication of spies and exchange of encrypted messages to reduce the likelihood that a virus (man-in-the middle) could influence communication between a server, such as server 110, and the spy 210.

As an example, for video-on-demand service, the spy 210 preferably observes the client 210 while client 210 executes the application. The spy 210 then reports to the server 110 any symptoms that indicate that a virus may have entered the client 120. These symptoms may include disk access transactions and/or network packet transmissions while the application is running.

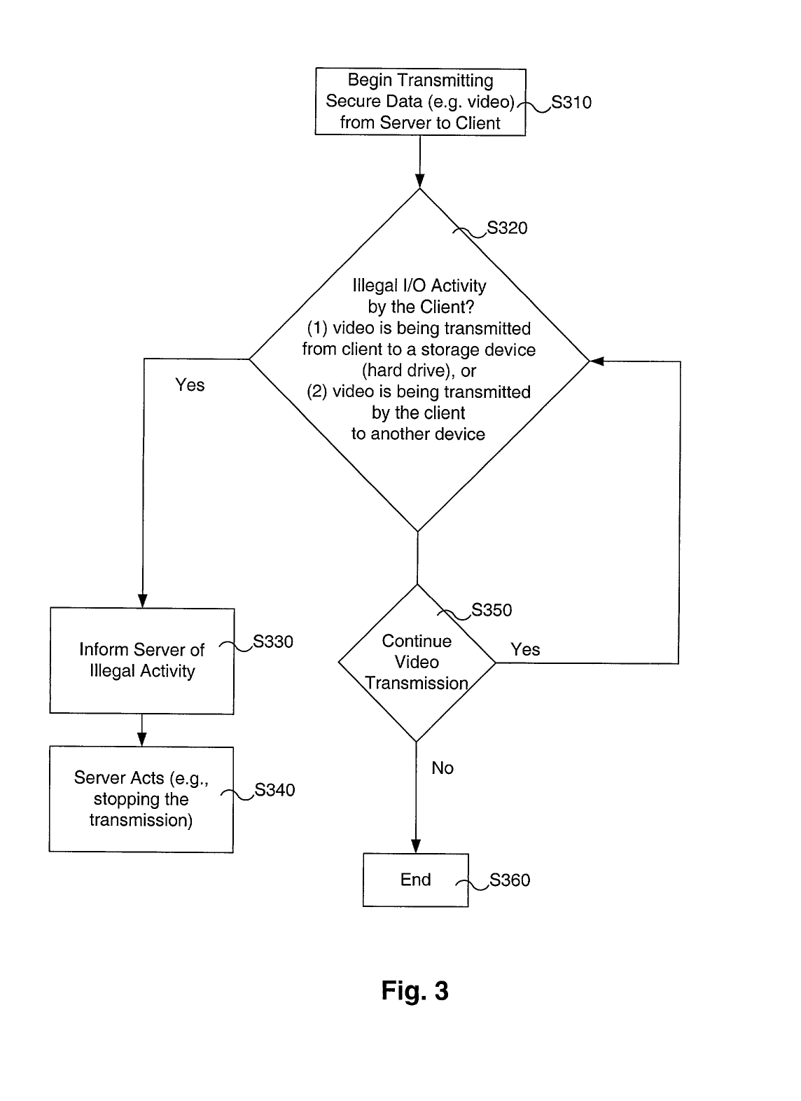

FIG. 3 illustrates a method for detecting illegal activity during the transmission of secure data to a client 120, in accordance with methods and systems consistent with the invention. The secure data may be used by either a realtime or non-realtime application executed by the client to, for example, display a video stream to a user. This application may be stored in the storage 240 (e.g., a hard drive, CD-ROM, etc.) in the client and executed by processor 220 in the client 120.

As illustrated, the server 110 first begins transmitting the secure data (e.g. video data) to the client 120. (S310) As the video stream arrives at the client 120, it is stored in client's memory 230 and displayed on the client's monitor (not shown). Meanwhile, the spy 210 observes all of the client's disk and network transactions (S320). As such, if a virus in the client 120 copies the video stream data to a file on the disk or transmits it over the network to another system, the spy 210 detects such activity. If an unauthorized activity is detected, the spy 210 then informs the server 110 of this unauthorized activity (S330). The server 110 then acts appropriately by, for example, stopping the service (S340). If no unauthorized activity is detected, the client 120 continues to receive the secure data (S350). This then continues until either unauthorized activity is detected or there is no more data to be transmitted to the client (e.g., the movie ends) (S360).

Although, this approach detects a virus, it may allow for some data loss, such as a data leak. This is because the spy will identify the existence of a virus after an unauthorized transaction occurs, i.e. a file write or network transmission. The maximum size, however, of the lost data may be limited to the size of the client's memory. In certain applications, this may be acceptable, as for example in the case of video-on-demand (movie) applications, where loss of only a very small fraction of a movie is not all that harmful.

In another embodiment, the spy 210 may bring the client 120 to a clean state prior to starting an application, i.e. a state where it is highly unlikely that there is a virus resident in memory 230 of the client. Then, the spy 210 observes the client computer 120 while the client 120 executes the application and reports to the server 1 10 any symptoms indicating that a virus may have entered the system and performing, for example, unauthorized disk accesses, network packet transmissions, etc. The client 120 may also be re-checked periodically to search for any undetected virus in the client computer. Such re-checking may be needed in the event of client activity that may allow a virus to enter the client 120 or become memory resident by, for example, initiating execution of a new program, etc.

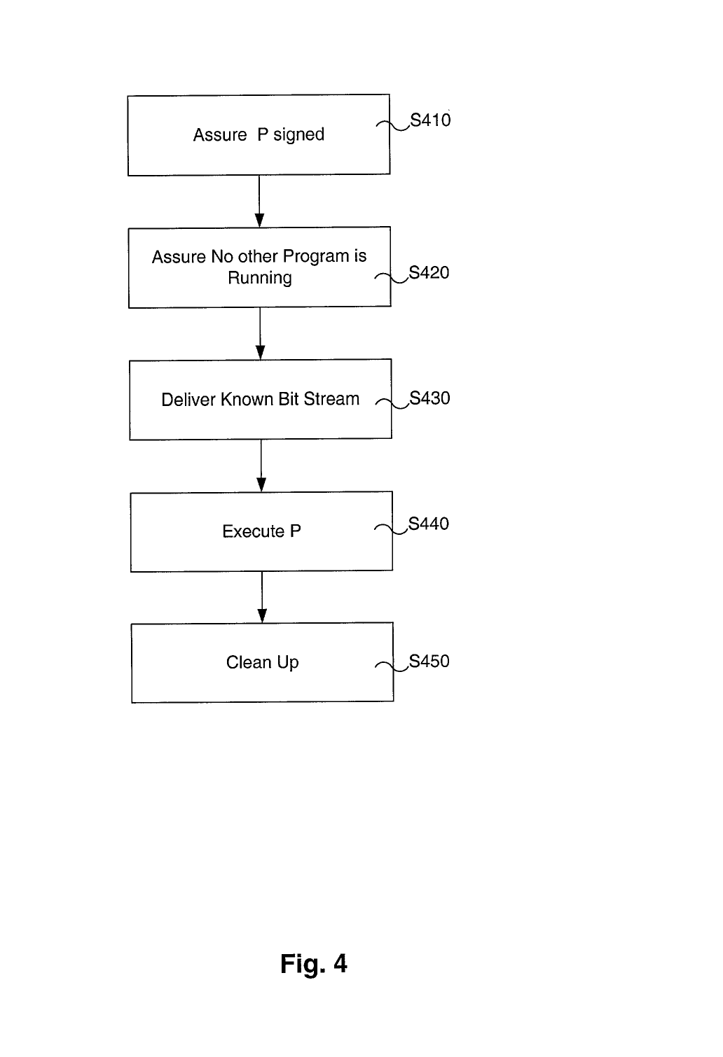

FIG. 4 illustrates a method for ensuring the safe execution of a non-realtime application in which the client computer is brought to a clean state prior to starting the application, in accordance with methods and systems consistent with the invention. For non-real time applications, the data used by the application is downloaded completely or wholly obtained prior to execution of the application. Examples of non-realtime applications include, for example, accessing video, picture, audio files or book data received and stored by the client computer, downloading and installing software programs and/or upgrades, downloading and playing games, etc. In such applications, the bit stream may be stored on the client in an encrypted form. The bit stream may be received by the client from a server over the Internet and then stored by the client for later use. In another embodiment, the encrypted bit stream may be stored on a floppy drive in the client. An application program is then used to decrypt the stored bit stream and present the corresponding information (e.g. video, book data, etc.) to the user.

This method may be embodied in a routine stored in the client 120 that uses the spy 210 to read/write to/from the client's memory. This routine will be referred to as Safe_Exec(P), where P represents the application program that the client 120 desires to execute.

As illustrated, this method includes the following steps, which will be discussed in more detail below: assure that P is signed, i.e. that it is a safe program to execute (S410); assure that no other program is running (S420); deliver a known stream of bits (e.g., keys) to P from the spy (as long as the two previous assurances are given) (S430); execute P (S440); and, clean up when P has finished execution (S450).

As illustrated, the first step performed by the Safe_Exec(P) routine verifies that the application program the client desires to execute is signed (S410). As discussed above, this program may retrieve and display a movie or book, or some other type of application for which security is desired. There are various ways for which Safe_Exec(P) may verify that the program is a safe program. These may include, for example, verifying the program using an electronic signature.

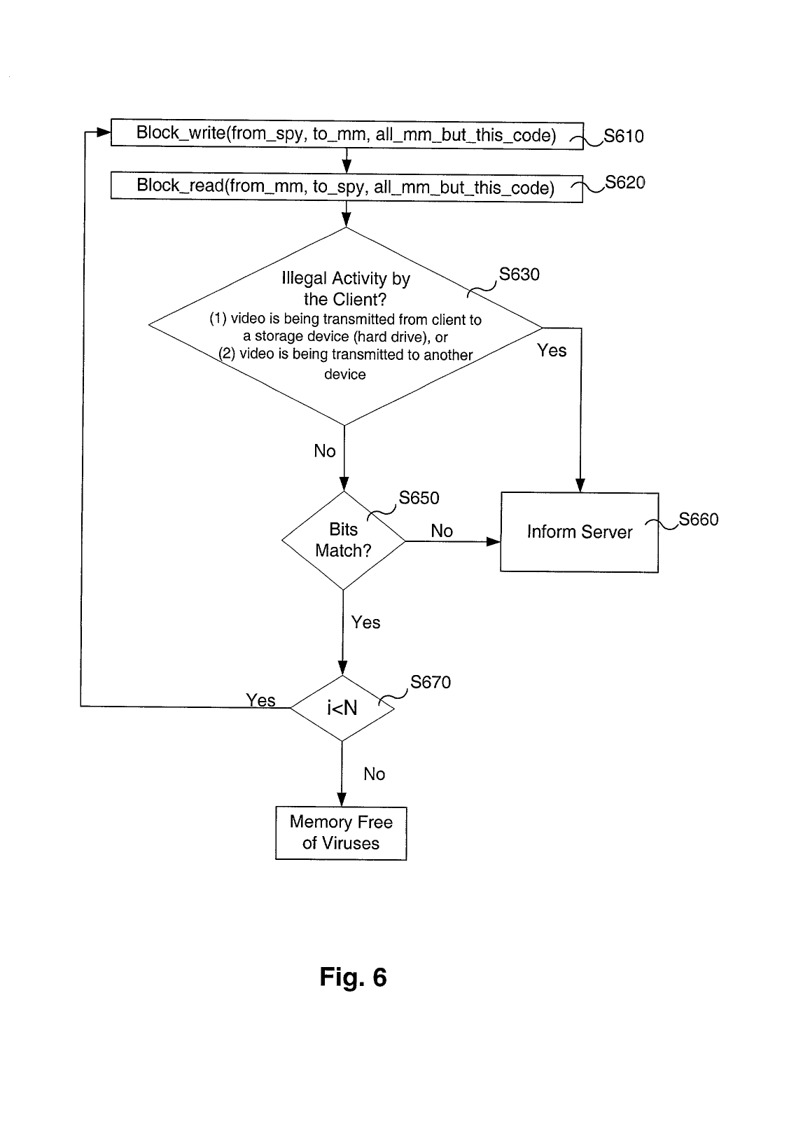

Next, the Safe_Exec(P) routine verifies that the client 120 is not running any unauthorized programs (S420). A detailed description of this step will be discussed below with reference to FIG. 6.

After the Safe_Exec(P) routine verifies that the memory 230 in client 120 is free of viruses, the Safe_Exec(P) routine may provide a known stream of bits to the program from the spy 210 (S430). This stream of bits may be a series of encryption keys for decrypting the stored data, keys for communicating control information with a server, charging (billing) information, etc.

Next, the client 120 executes the application program (S440). The application program then decrypts the stored data for use/viewing by the user. As discussed above, this program may permit, for example, a user to view a movie or book corresponding to the previously received encrypted stream of bits. Further, as will be obvious to one of skill in the art, the application program may be initiated prior to transmitting the stream of bits discussed with reference to step 430.

Also, during execution of the program, the spy may check for any unauthorized I/O activity, such as, unauthorized disk accesses or network transactions. In the event such unauthorized activity is detected, the spy may send a message to the application program and/or the server to terminate the program.

After the program is executed, Safe_Exec(P) routine cleans up the client computer (S450). This step ensures that any potentially sensitive information of the server or spy is removed from the client computer's memory. For example, during this step encryption/decryption keys or other session information (such as, charging/payment information, etc.) may be removed.

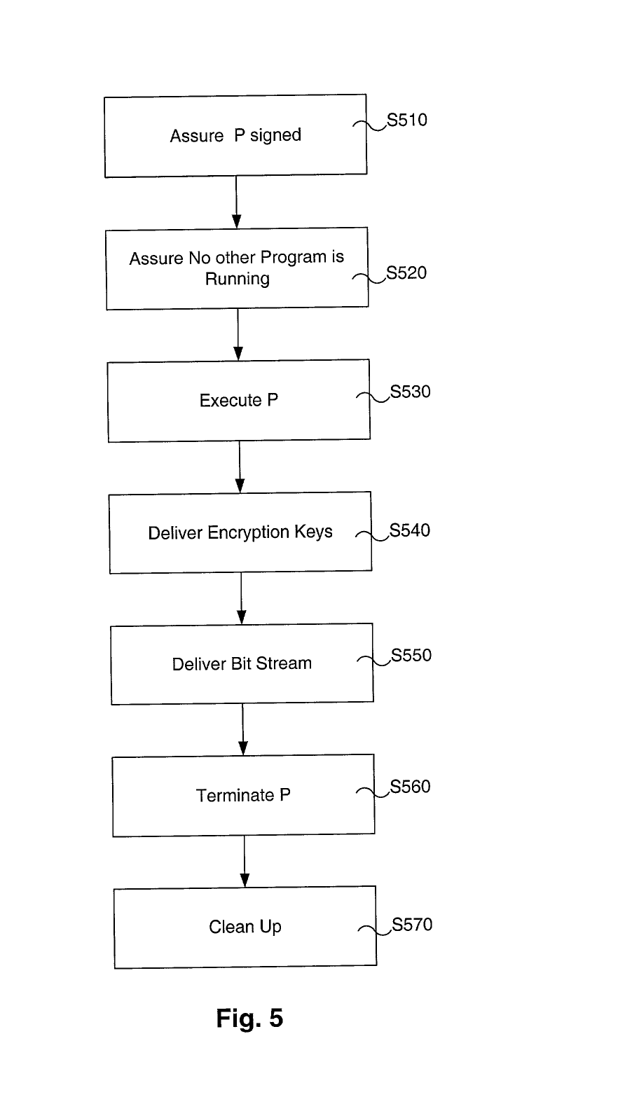

FIG. 5 illustrates a method for ensuring the safe execution of a realtime application, in accordance with methods and systems consistent with the invention. Examples of realtime applications may include, for example, transmitting a movie, a video, or an audio program for real-time use and/or viewing by a user, video-conferencing, subscription services (e.g., TV distribution, etc.), online purchasing, etc. In such applications, a secure stream of bits is preferably transmitted from a server to the client in an encrypted form. The application program then decrypts the received stream of bits and presents the corresponding information (e.g. movie, video, audio, etc.) to the user.

This method may be embodied in a routine stored in the spy 210 that the client computer 120 may execute. Alternatively, this routine may instead be executed by a processor in the spy 210. As with the method discussed with reference to FIG. 4, this routine will be referred to as Safe_Exec(P), where P represents the application program that the client 120 desires to execute.

As illustrated, this method includes the following steps, which will be discussed in more detail below: assure that P is signed, i.e. that it is a safe program to execute (S510); assure that no other program is running (S520); execute P (S530); deliver a known stream of bits (e.g., keys) to P from the spy (as long as the two previous assurances are given) (S540); deliver a secure stream of bits to the client (S550); terminate P (S560); and then, clean up (S570).

As illustrated, the Safe_Exec(P) routine verifies that the program the client desires to execute is signed (S510). As discussed above, there are various ways for which Safe_Exec(P) may verify that the program is a safe program.

Next, the Safe_Exec(P) routine verifies that the client computer is not running any unauthorized programs (S520). A detailed description of this step will be discussed below with reference to FIG. 6.

Next, the client-computer executes the application program (S530). This application program may include, for example, a program for viewing a movie, a video, an audio program, or any other type of real-time application.

Next, the spy preferably transmits a known stream of bits to the program (S540). This stream of bits may include a series of encryption keys that will be used by the application program to decrypt the secure data it receives from the server. Further, these bits may be bits for communicating control information with the server, charging (billing) information, etc.

Next, the application program receives the secure bit stream corresponding to the movie, video, or audio program the user wishes to receive (S550). The server transmits this bit stream to the client in an encrypted form. The application program then decrypts the data for use and/or viewing by the user using the previously received encryption keys.

The transmission of this bit stream from the server to the client may be initiated by the application sending a request to the server indicating that it is safe and ready to receive the bit stream. This request may be transmitted to the server in an encrypted form using the encryption keys received from the spy. In response, to this request, the server may begin transmitting the bit stream to the client.

Further, during the reception and decryption of the bit stream, the spy may check to ensure that there is no unauthorized I/O activity (e.g., unauthorized disk accesses or network transmissions). In the event, the spy detects any such unauthorized activity, the spy may send a message to the server. In response, the server may stop transmitting the bit stream to the client.

Once the bit stream ends or is terminated, the application program terminates (S560). Next, the Safe_Exec(P) routine cleans the client computer (S570). This step ensures that any potentially sensitive information of the server or spy is removed from the client computer's memory. For example, during this step encryption/decryption keys or other session information (such as, charging (payment) information, etc.) may be removed.

FIG. 6 illustrates a method that may be used for verifying that the client computer is not running any unauthorized programs, in accordance with methods and systems consistent with the invention. This method may be used during the above described methods to ensure that there are no unauthorized memory-resident programs. It may be used in steps 420 and 520 during the above methods described with reference to FIGS. 4 and 5, respectively.

In this embodiment, the method assumes that the virus program needs to reside in the client's memory to execute. Further, this method may be embodied in a program (hereinafter referred to as “Virus_Id( )”) that is loaded into the client's memory and executed by the client's processor.

As illustrated, first, the Virus_Id( ) program writes a sequence of bits from the spy to all of the client computer's expected available memory (S610). That is, the Virus_Id( ) program writes M-Lid bits to the client's memory, where M is the size of the client's memory in bits, and Lid is the size in bits of the Safe_Exec(P) routine, if the client's processor is executing this routine. Further, the sequence of bits written to the client's memory may be a pseudo-random sequence.

In another embodiment, only the Virus_Id( ) program is uploaded from the spy to the client's memory. In this embodiment, Lid is the size in bits of the Virus_Id( ) program. In yet another embodiment, both the Safe_Exec(P) routine and Virus_Id( ) may be executed by a processor in the spy. In such an embodiment, Lid may be zero. The original bits that are to be written to the client's memory may be stored in the spy.

In another embodiment, the spy 210 determines the size of the client's memory 230, M. For example, the spy 210 may determine the size of the client's memory 230 in a similar fashion to how conventional processors determine the size of their main memory during initialization.

Next, the Virus_Id( ) program attempts to read these bits from the client computer memory (S620). The spy then checks the retrieved bits against the bits that were written to the client's memory. Further, during the process of reading and writing bits, the spy observes the client for any unauthorized disk accesses or network transactions (S630).

Thus, if a virus exists in the client's memory, the virus will need to correctly guess which bits were to be written in the memory in which the virus resides. Further, if the virus attempts to store these bits on a disk, it will be identified by the spy. The probability of making a correct guess is: 2^{-L}, where L is the size of the virus in bits.

Next, if the spy detected any unauthorized activity, it informs the server (S660). Further, the spy checks to ensure that the read bits match those that were to be written into the memory (S650). If they do not match, the spy informs the server (S660).

Otherwise, the above process of reading and writing bits is repeated until it has been repeated N times, where N is a value chosen such that the probability that a small-size virus could correctly guess the bits is reduced (S670).

The following database provides a program, Virus_Id( ), that may be used to verify there are no unauthorized programs resident in the client's memory:

Virus_Id( ) /*identifies if a virus is resident in main memory*/

for (i=1; i<N; i++)

{

block_write(from_spy, to_mm, all_mm_but_this_code);

block_read(from_mm, to_spy, all_mm_but_this_code);

}

jump addr_( );

where in the first block write command, from-spy indicates where the bits are retrieved from, to_mm indicates that the bits are being written to the client computer memory, and all_mm_but this_code indicates that the number of bits written to the client computer is equal to M−L_{id}. Further, in the block read, from_mm indicates that the bits are retrieved from the client's memory, and to_spy indicates that the read bits are sent to the spy.

The program, Virus_Id( ) program may be uploaded to the client's memory and executed by the client's processor. Then, the spy checks to determine if the read bits match those that were to be written into the client's memory. If not, the spy informs the server. In another embodiment, Virus_Id( ) is executed by processor in the spy. In this embodiment, the number of bits that the program attempts to write in to the client's memory is equal to the size of the memory.

While it has been illustrated and described what is at present considered to be the preferred embodiment and methods of the present invention, it will be understood by those skilled in the art that various changes and modifications may be made, and equivalents may be substituted for elements thereof without departing from the true scope of the invention.

In addition, many modifications may be made to adapt a particular element, technique or, implementation to the teachings of the present invention without departing from the central scope of the invention. Therefore, it is intended that this invention not be limited to the particular embodiment and methods disclosed herein, but that the invention includes all embodiments falling within the scope of the appended claims.

What is claimed is:

1. A method for identifying the existence of one or more unknown programs in a system, said method comprising the steps of:
attempting to write a predetermined number of bits to a memory in the system, wherein the predetermined number of bits is based on size of the memory;
determining if any of the bits attempted to be written to the memory are transmitted to someplace other than the memory;
reading from the memory a number of bits equal to the predetermined number of bits attempted to be written to the memory;
determining if the bits read from the memory match the bits attempted to be written to the memory; and
determining that no unknown program is resident in the memory if the read bits match the bits attempted to be written and that none of the bits attempted to be written were transmitted to someplace other than the memory.

2. The method of claim 1, further comprising the step of:
executing an application program if it is determined that no unknown program is resident in the memory.

3. The method of claim 2, further comprising the steps of:
receiving video data from a server; and
displaying the video data using the application program.

4. The method of claim 2, further comprising the steps of:
receiving information regarding reading material from a server; and
displaying the reading material using the application program.

5. The method of claim 2, further comprising the steps of:
receiving, from a server, a stream of bits for use by the application program;
determining if any of the bits are improperly transmitted to someplace other than for use by the application program; and
transmitting a message to the server if it is determined that any of the bits are improperly transmitted.

6. The method of claim 1, further comprising the steps of:
assuring that an application program is signed;
executing the application program if it is determined no unknown program is resident in the memory; and
delivering a stream of bits to the system for use by the application program.

7. The method of claim 1, wherein the method is repeated a predetermined number of times.

8. The method of claim 1, wherein the predetermined number of bits that are attempted to be written to the memory include a pseudo-random sequence of bits.

9. A system, comprising:
at least one processor;
a memory;
at least one storage device,
wherein the at least one storage device stores a program that the at least one processor executes to perform a method comprising the steps of:
attempting to write a predetermined number of bits to the memory, where the predetermined number is based on size of the memory;
reading a number of bits from the memory that is equal to the predetermined number of bits attempted to be written to the memory, and
determining if the bits read from the memory match the bits attempted to be written to the memory; and
a circuit that determines if any of the bits attempted to be written to the memory are transmitted to someplace other than the memory.

10. The system of claim 9, wherein the at least one storage device stores an application program that the at least one processor executes to perform a method comprising the steps of:
receiving video data from a server; and
displaying the video data,
wherein the application program is only executed if it determined that the bits read from the memory match the bits attempted to be written to the memory and that none of the bits attempted to be written to the memory are transmitted someplace other than the memory.

11. The system of claim 9, wherein the at least one storage device stores an application program that the at least one processor executes to perform a method comprising the steps of:
receiving information regarding reading material from a server; and
displaying the reading material;
wherein the application program is executed if it is determined that the bits read from the memory match the bits attempted to be written to the memory and that none of the bits attempted to be written to the memory are transmitted to someplace other than the memory.

12. The system of claim 9, wherein the at least one processor executes the application program if it is determined that no unknown program is resident in the memory, and wherein the system receives a stream of bits that are used by the application program.

13. The system of claim 12, wherein the application program is executed if it is determined that the application program is signed.

14. The system of claim 12, wherein the circuit further determines if any of the stream of bits received are improperly transmitted to someplace other than for use by the application program.

15. The system of claim 9, wherein the at least one storage device storing the program and the circuit are included on a board in the system, and wherein a bus interconnects the board, the memory, and the at least one processor.

16. The system of claim 9, wherein the at least one storage device storing the program and the circuit are included on a Personal Computer (PC) card.

17. An apparatus for identifying one or more unknown programs in a system, said apparatus comprising:
a storage device storing a program that a processor executes to perform a method comprising the steps of:
attempting to write a predetermined number of bits to a memory in the system,
reading a number of bits from the memory that is equal to the predetermined number of bits attempted to be written to the memory, and
determining if the bits read from the memory match the bits attempted to be written to the memory; and
a circuit that determines if any of the bits attempted to be written to the memory are transmitted to someplace other than the memory.

18. The apparatus of claim 17, wherein the apparatus is a Personal Computer (PC) card for use in a computer.

19. The apparatus of claim 17, wherein the apparatus is a board for use in a computer.

20. An apparatus for identifying one or more unknown programs in a system, said apparatus comprising:
a circuit that attempts to write a predetermined number of bits to a memory in the system, reads a number of bits from the memory that is equal to the predetermined number of bits attempted to be written to the memory, determines if the bits read from the memory match the bits attempted to be written to the memory, and determines if any of the bits attempted to be written to the memory are transmitted to someplace other than the memory.

21. A system, comprising:
means for attempting to write a predetermined number of bits to a memory in the system, wherein the predetermined number of bits is based on size of the memory;
means for determining if any of the bits attempted to be written to memory are transmitted to someplace other than the memory;
means for reading from the memory a number of bits that is equal to the predetermined number of bits attempted to be written to the memory;
means for determining if the bits read from the memory match the bits attempted to be written to the memory; and
means for determining that no unknown program is resident in the memory if the read bits match the bits attempted to be written to the memory and that none of the bits attempted to be written to the memory are transmitted to someplace other than the memory.
